(19) United States
(12) Patent Application Publication
(10) Pub. No.: US 2008/0190921 A1
(43) Pub. Date: Aug. 14, 2008

(54) CLOTHES HAMPER

(75) Inventors: Noah McNeely, Suwanee, GA (US); Nathan Pascarella, Buford, GA (US); Michael Carlson, Atlanta, GA (US)

Correspondence Address: GIFFORD, KRASS, SPRINKLE,ANDERSON & CITKOWSKI, P.C, PO BOX 7021, TROY, MI, 48007-7021, US

(73) Assignee: The Evercare Company, Alpharetta, GA (US)

(21) Appl. No.: 11/672,658

(22) Filed: Feb. 8, 2007

(51) Int. Cl. B65D 8/14; B65D 85/18; B62B 3/02

(52) U.S. Cl. 220/6; 220/9.4; 280/35

(57) ABSTRACT

A clothes hamper having a base with a first and second portions joined by a hinge mechanism. A first bin is mounted to the first portion of the base while a second bin is mounted to the second portion of the base. Each bin is collapsible between an expanded position in which the tops and bottoms of the bin are spaced apart from each other, and a collapsed position in which the top and bottom of the bin are positioned closely adjacent each other and with the sidewall for each bin sandwiched between the top and the bottom. With the bins in their collapsed position, the hinge mechanism enables the base portions to be folded over on each other so that the bins are sandwiched in between the base portions for compact storage.

### BACKGROUND OF THE INVENTION

I. Field of the Invention

The present invention relates to a clothes hamper.

II. Description of Related Art

There are many previously known clothes hampers of the type used in a laundry room. These previously known clothes hampers, however, all suffer several common disadvantages.

One disadvantage of the previously known clothes hampers is that such hampers consisted of little more than a bulky basket dimensioned to receive clothes. As such, such clothes hampers consumed a large amount of storage space when not in use.

A still further disadvantage of many of these previously known hampers is that it was difficult to move the hamper from one room to another, e.g. from a bedroom and to the laundry room. Indeed, these previously known hampers oftentimes provided little more than a handle on one side of the hamper to facilitate lifting and carrying the hamper.

### SUMMARY OF THE PRESENT INVENTION

The present invention provides a clothes hamper which overcomes all of the above-mentioned disadvantages of the previously known devices.

In brief, the clothes hamper of the present invention comprises a base having a first portion and a second portion joined together by a hinge mechanism. In one embodiment of the invention, this hinge mechanism constitutes a flexible portion of the base.

A first bin is attached to the first base portion while, similarly, a second bin is attached to the second base portion. Each bin, furthermore, includes a top, a bottom, and a flexible sidewall extending between the top and the bottom.

Each sidewall of the bin is collapsible between an expanded position and a collapsed position. In its expanded position, the top and bottom of the bin are spaced apart from each other so that the bin forms a receptacle for receiving clothes. Conversely, in its collapsed position, the top of the bin is collapsed on top of the bottom so that the top and bottom are positioned closely adjacent to each other and with the now collapsed sidewall sandwiched therebetween.

With the bins in their collapsed position, the hinge mechanism enables the first and second portions of the base to be folded on top of each other so that the collapsed bins are sandwiched together and entrapped between the first and second portions of the base. While folded to its storage position, a latch secures the base portions together in their folded position for compact storage of the clothes hamper.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a preferred embodiment of the present invention;

FIG. 2 is a side view illustrating a preferred embodiment of the present invention;

FIG. 3 is a view similar to FIG. 2, but illustrating the bins in a collapsed position;

FIG. 4 is an exploded view illustrating a preferred embodiment of the present invention; and

FIG. 5 is a side view illustrating the clothes hamper in a collapsed and folded storage position.

### DETAILED DESCRIPTION OF A PREFERRED EMBODIMENT OF THE PRESENT INVENTION

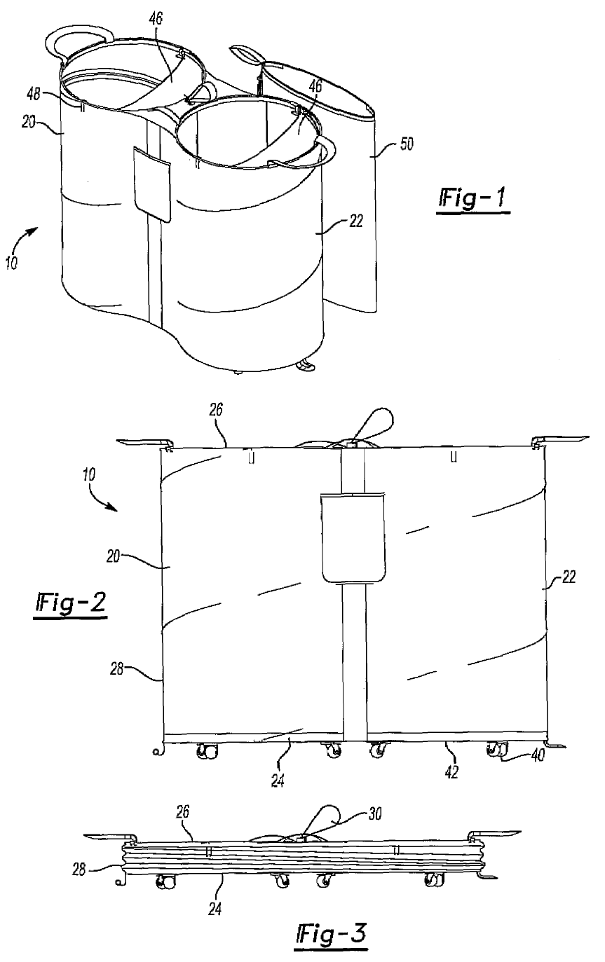

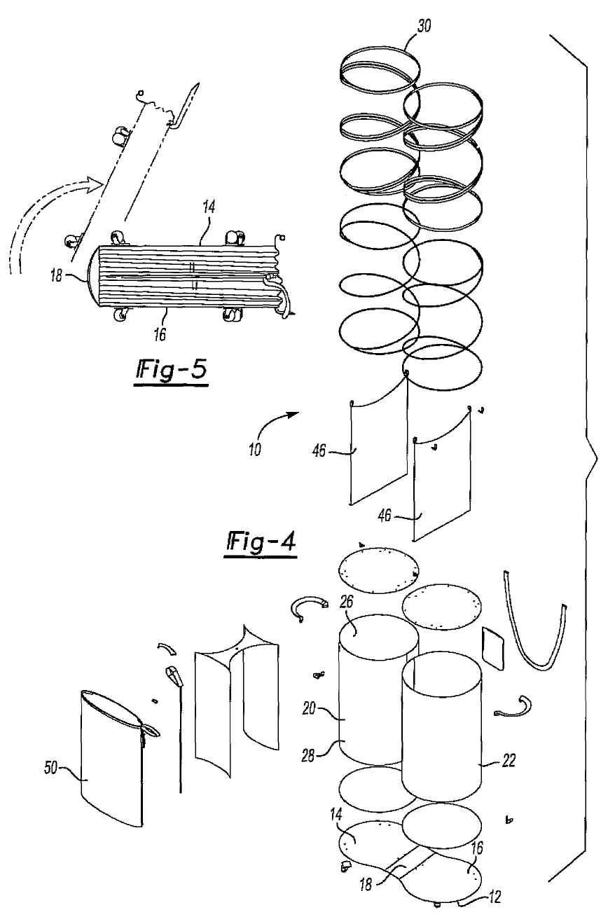

With reference first to FIGS. 1, 2 and 4, a preferred embodiment of a clothes hamper 10 according to the present invention is shown. The clothes hamper 10 includes a base 12 (FIG. 4) having a first portion 14 and a second portion 16. The base portions 14 and 16 are joined together by a hinge mechanism 18. This hinge mechanism 18, furthermore, preferably comprises a portion of flexible material which allows the base portions 14 and 16 to be folded on top of each other.

A first bin 20 is attached to an upper surface of the first base portion 14. Similarly, a second bin 22 is attached to an upper surface of the second base portion 16.

The bins 20 and 22 are substantially identical to each other so that only the bin 20 will be described in detail, it being understood that a like description shall also apply to the other bin 22. The bin 20 includes a bottom 24, an open top 26 and a sidewall 28 extending from the open top 26 and to the bottom 24 of the bin 20. The bin 20 is illustrated in the drawing as cylindrical in shape, but other shapes may be used without deviation from the spirit or scope of the invention.

The bin sidewalls 28 are made of a flexible material, such as cloth. A helical compression spring 30 is attached to or embedded within the bin sidewall 28 so that the spring 30 extends from the top 26 of the bin 20 and to its bottom 24. The helical spring 30 urges the bin to an expanded position, illustrated in FIGS. 1 and 2.

With reference now to FIGS. 2, 3 and 5, the bins 20 and 22 are movable between an expanded position, illustrated in FIG. 2, and a collapsed position, illustrated in FIG. 3 by compressing the springs 30 (FIG. 4). In the expanded position, the open top 26 of each bin 20 and 22 is spaced from its bottom 24 so that each bin forms a receptacle for receiving clothes. Conversely, in its collapsed position, illustrated in FIG. 3, the open top 26 is positioned closely adjacent the bottom 24 and with the sidewall 28 sandwiched in between. Any conventional means, such as a tie 30, may be used to secure the bins 20 and 22 in their collapsed position.

With reference now particularly to FIG. 5, with the bins 20 and 22 in their collapsed position, the hinge mechanism 18 enables the base portion 16 to be folded over on top of the base portion 14 so that the collapsed bins 20 and 22 are sandwiched in between an upper surface of each base portion 14 and 16. With the base portion in the folded position illustrated in FIG. 5, a loop 32 attached to one base portion 16 engages a fastener 34 on the other base portion 14 to hold the base portions 14 and 16 together in their folded position. Furthermore, with the base portions 14 and 16 in their folded positions as illustrated in FIG. 5, the overall clothes hamper is very compact in construction for efficient storage.

With reference now particularly to FIG. 2, at least one, and preferably several rollers 40 are attached to a bottom 42 of the base 12. These rollers 40 enable the entire hamper 10 to be easily rolled along a floor.

With reference now to FIGS. 1 and 4, the two clothes bins 20 and 22 thus allow two different kinds of clothes, e.g. white clothes and colored clothes, to be stored in separate bins. In some situations, however, it is desirable to segregate the different clothes into three or even four different types.

To that end, a divider 46 is optionally disposed in one or both of the bins 20 and 22. The divider 46 is flexible in construction and attached to the top of its associated bin 20 or 22 by a simple hook 48. Each divider 46 thus effectively subdivides its associated bin into two different compartments.

Still referring to FIGS. 1 and 4, a bag 50 is optionally attached to the outside of one or both bins 20 and 22. This bag may be used for storage of any desired material, such as supplies oftentimes used for laundry and cleaning.

From the foregoing, it can be seen that the present invention provides a unique clothes hamper which may be easily moved and is also folded into a compact configuration for storage when its use is not required. Having described my invention, however, many modifications thereto will become apparent to those skilled in the art to which it pertains without deviation from the spirit of the invention as defined by the scope of the appended claims.

I claim:

1. A clothes hamper comprising
a base having a first and a second portions joined by a hinge mechanism,
a first and second bin, each bin having a top, a bottom and a sidewall, said first bin being attached to an upper surface of said first base portion and said second bin being attached to an upper surface of said second base portion,
wherein said sidewall of each bin is collapsible between an expanded position in which said top and bottom of each said bin are spaced apart from each other, and a collapsed position in which said top and said bottom of each said bin are positioned adjacent each other with each said sidewall sandwiched between said top and said bottom of its respective bin,
wherein said base is foldable between an operative position in which said base portions are positioned in a side by side relationship, and a storage position in which, while said bins arc in said collapsed position, said upper surfaces of said base portions face each other with said collapsed bins sandwiched between said upper surfaces of said base portions.

2. The invention as defined in claim 1 wherein said bin sidewalls comprise a flexible material.

3. The invention as defined in claim 2 wherein said flexible material comprises cloth.

4. The invention as defined in claim 2 and comprising a pair of compression springs, one compression spring being attached to each sidewall and extending from said top to said bottom of each said bin.

5. The invention as defined in claim 1 wherein said hinge mechanism comprises a flexible portion of said base.

6. The invention as defined in claim 1 and comprising a latch assembly for retaining said base in said storage position.

7. The invention as defined in claim 1 and comprising a flexible divider removably positioned in one of said bins.

8. The invention as defined in claim 1 and comprising at least one roller attached to a lower surface of said base.

9. The invention as defined in claim 8 and comprising a plurality of rollers attached to a lower surface of said base.

10. The invention as defined in claim 1 and comprising a divider detachably mounted within at least one of said bins.
